(19) United States
(12) Patent Application Publication
(10) Pub. No.: US 2017/0267568 A1
(43) Pub. Date: Sep. 21, 2017

(54) Thermal Bonding of Multi-Layer Glass Capacitors

(71) Applicant: Sandia Corporation, Albuquerque, NM (US)

(72) Inventors: Rudeger H.T. Wilke, Albuquerque, NM (US); Harlan James Brown-Shaklee, Albuquerque, NM (US)

(21) Appl. No.: 15/448,250

(22) Filed: Mar. 2, 2017

Related U.S. Application Data
(60) Provisional application No. 62/308,723, filed on Mar. 15, 2016.

(51) Int. Cl. C03B 23/203; H01G 4/30; H01G 4/008; H01G 4/10

(52) U.S. Cl. CPC C03B 23/203; H01G 4/105; H01G 4/30; H01G 4/008

(57) ABSTRACT

High energy density multi-layer capacitors comprise inner electrodes buried within thin layers of alkali-free glass. The multi-layer glass capacitor can be fabricated by heating a plurality of capacitor layers above the annealing temperature of the glass to thermal bond the layers together. The edge margin of the buried electrodes can be selected to provide an adequate protection level from high-voltage flashover of the multi-layer glass capacitor. For example, an edge margin of 0.125″ can hold off about 10 kV in air.

### CROSS-REFERENCE TO RELATED APPLICATION

This application claims the benefit of U.S. Provisional Application No. 62/308,723, filed Mar. 15, 2016, which is incorporated herein by reference.

### STATEMENT OF GOVERNMENT INTEREST

This invention was made with Government support under contract no. DE-AC04-94AL85000 awarded by the U.S. Department of Energy to Sandia Corporation. The Government has certain rights in the invention.

### FIELD OF THE INVENTION

The present invention relates to thin film capacitors and, in particular, to a method for thermal bonding of multi-layer glass capacitors.

### BACKGROUND OF THE INVENTION

Alkali-free glasses are a promising class of materials for high energy density capacitors due to their high dielectric breakdown strengths. See T. J. Patey et al., “Glass as dielectric for high temperature power capacitors,” MRS Proceedings 1679 (2014); H. Lee et al., Journal of the American Ceramic Society 93(8), 2346 (2010); and N. J. Smith et al., Materials Letters 63(15), 1245 (2009). Although their dielectric constant can be considerably lower than glass ceramics, the lack of microstructural defects at the crystalline ceramic/amorphous glass interface and corresponding higher breakdown strengths more than compensates for this difference. See E. P. Gorzkowski et al., Journal of Electroceramics 18(3-4), 269 (2007). The energy storage density of a dielectric is described by U=0.5_{ε0εr}E², hence given the general trend of decreasing breakdown strengths with increased dielectric constants, it is perhaps not surprising that some of the highest energy storage densities are observed in materials with low to moderate permittivities and high breakdown strengths. See A. J. Moulson et al., Electroceramics: Materials, Properties, Applications. 2nd ed. 2003, Hoboken, N.J.: Wiley; J. McPherson et al., Applied Physics Letters 82(13), 2121 (2003); B. Chu et al., Science 313(5785), 334 (2006); X. Zhou et al., Applied Physics Letters 94(16), (2009); and E. K. Michael and S. Trolier-McKinstry; Journal of the American Ceramic Society 98(4), 1223 (2015).

The high intrinsic breakdown strengths of alkali-free glass (>1100 MV/m) are due in part to the limited ionic mobility resulting from the low sodium content (˜100 ppm). See T. Murata et al., Journal of the American Ceramic Society 95(6), 1915 (2012); and P. Dash et al., Applied Physics Letters 102(8), (2013). However, the modest dielectric constant (˜5-6) requires a large area/thickness ratio in order to achieve appreciable levels of capacitance. At present, most commercially available alkali-free glass are 100-200 μm in thickness—requiring the glasses be thinned further.

Therefore, a need remains a viable path to manufacturing high capacitance and high breakdown strength devices out of alkali-free glass.

### SUMMARY OF THE INVENTION

The present invention is directed to a method for thermal bonding of a a multi-layer glass capacitor, comprising assembling a plurality of capacitor layers, each layer comprising opposing electrode layers on opposing sides of an alkali-free glass sheet, wherein the edges of the electrode layers are offset from the edges of the glass sheet by an edge margin, and heating the assembly to above the annealing temperature of the alkali-free glass, thereby causing the glass sheets to bond together at the edge margins. The thickness of the glass sheets can be less than 25 μm. The edge margin can be selected to provide an adequate protection level from high-voltage flashover of the multi-layer glass capacitor. For example, an edge margin of 0.125″ can hold off about 10 kV in air.

### BRIEF DESCRIPTION OF THE DRAWINGS

The detailed description will refer to the following drawings, wherein like elements are referred to by like numbers.

FIG. 1 is a schematic illustration of a multi-layer capacitor.

FIG. 2(a) is a top-view photograph of laser machined glass sheet. FIG. 2(b) is a top-view photograph of a thermally bonded capacitor.

FIG. 3 is a graph of the frequency dependence of the capacitance of a 2-layer capacitor.

FIG. 4 is a graph of the RLC response of a 2-layer capacitor to a pulsed discharge.

### DETAILED DESCRIPTION OF THE INVENTION

High voltage multi-layer capacitors require the inner electrodes be “buried”. That is, there must be an insulating medium which prevents the electric field lines from circumventing the dielectric layers and allowing breakdown to occur via a flash-over event. While it is possible to use insulating fluids to penetrate voids between layers of dielectric, it is desirable in many applications to have a capacitor that is entirely solid state.

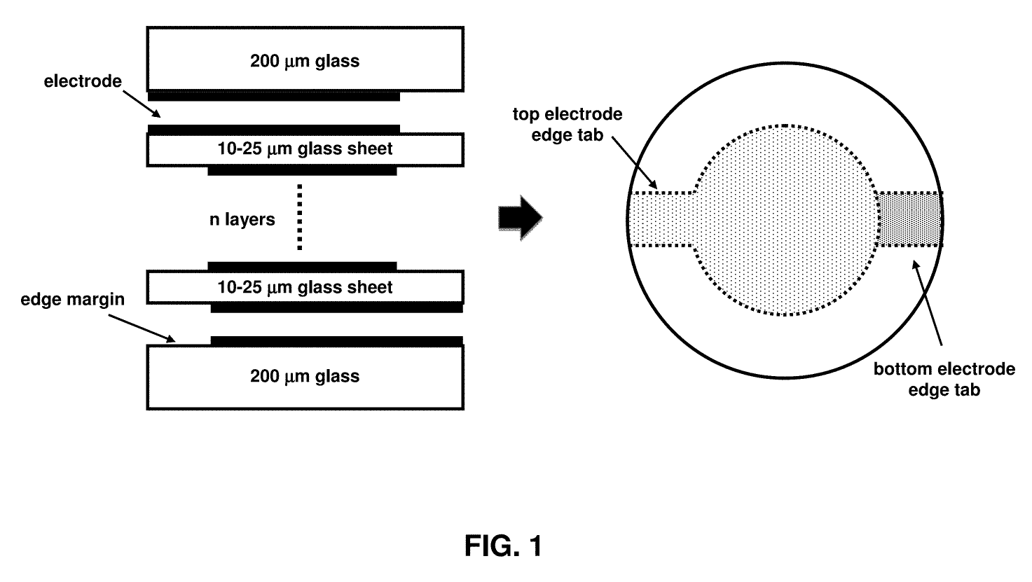

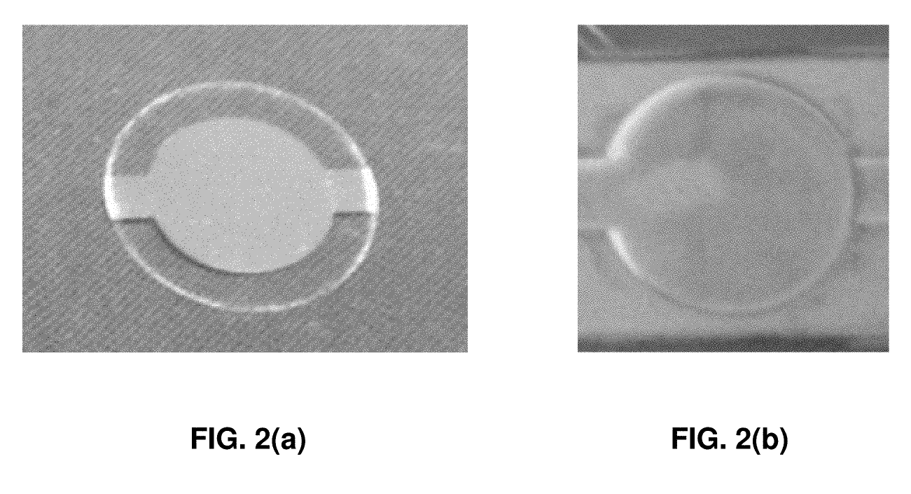

FIG. 1 shows an exemplary multi-layer glass capacitor according to the present invention. In this example, 0.75″ diameter electrodes with edge tabs were patterned on 200 μm thickness alkali-free glass circular support layer (e.g., Corning® Willow® glass). Ti/Pt electrodes can be used as a high temperature replacement for aluminum. The top and bottom 0.75″ diameter electrodes can be rotated 180° with respect to each other to provide opposing edge tabs, as seen in the top-view illustration the right-hand-side of the figure. Commercially available alkali-free glass sheets can be thinned to 10-25 μm thickness by etching in a 2.5% HF solution at an etch rate of approximately 0.01 μm/sec to provide the intermediate capacitor layers. Electrodes can be patterned on both sides of the thinned glass sheets with opposing edge margins on the opposing sides of the glass sheets. The electrodes and glass sheets are preferably circular, but other geometries can also be used. The edge margin can be chosen to provide an adequate protection level from high-voltage flashover after the capacitor is assembled. For example, an edge margin of 0.125″ will hold off about 10 kV in air. The glass can be laser cut to form the individual capacitor layers. FIG. 2(a) is a top-view photograph of a single layer laser machined glass capacitor.

A multi-layer cylindrical capacitor can be fabricated by thermally bonding several individual circular layers together electrically in parallel to eliminate triple points. By heating the glass above its annealing point (˜700-750° C. for alkali-free borosilicate glass), the decrease in the viscosity of the glass allows the neighboring softened glass layers to react and intimately bond together. This creates an edge margin consisting of entirely high dielectric breakdown strength glass. FIG. 2(b) is a top view photograph of a thermally bonded multi-layer capacitor that was heated to about 850° C.

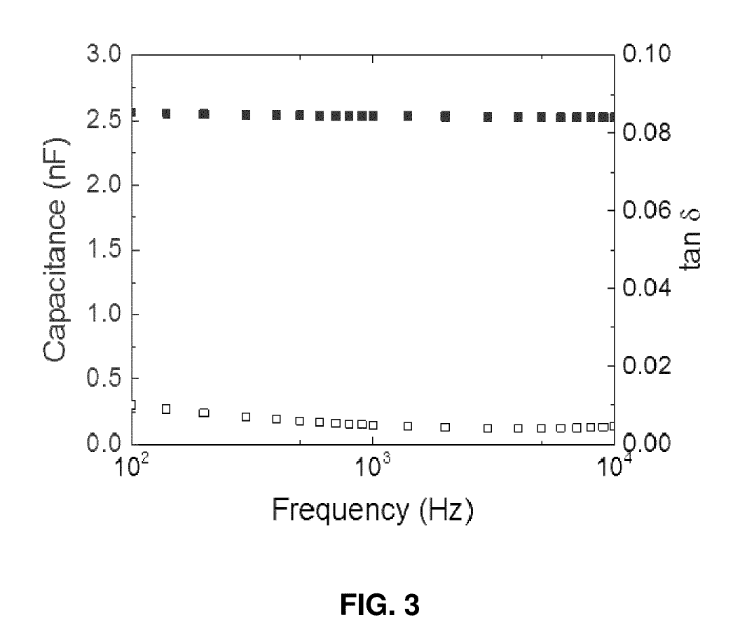

FIG. 3 is a graph of the frequency dependence of the capacitance of an exemplary 2-layer capacitor. At 1 kHz the capacitance is 2.5 nF with a loss tangent of 0.5%.

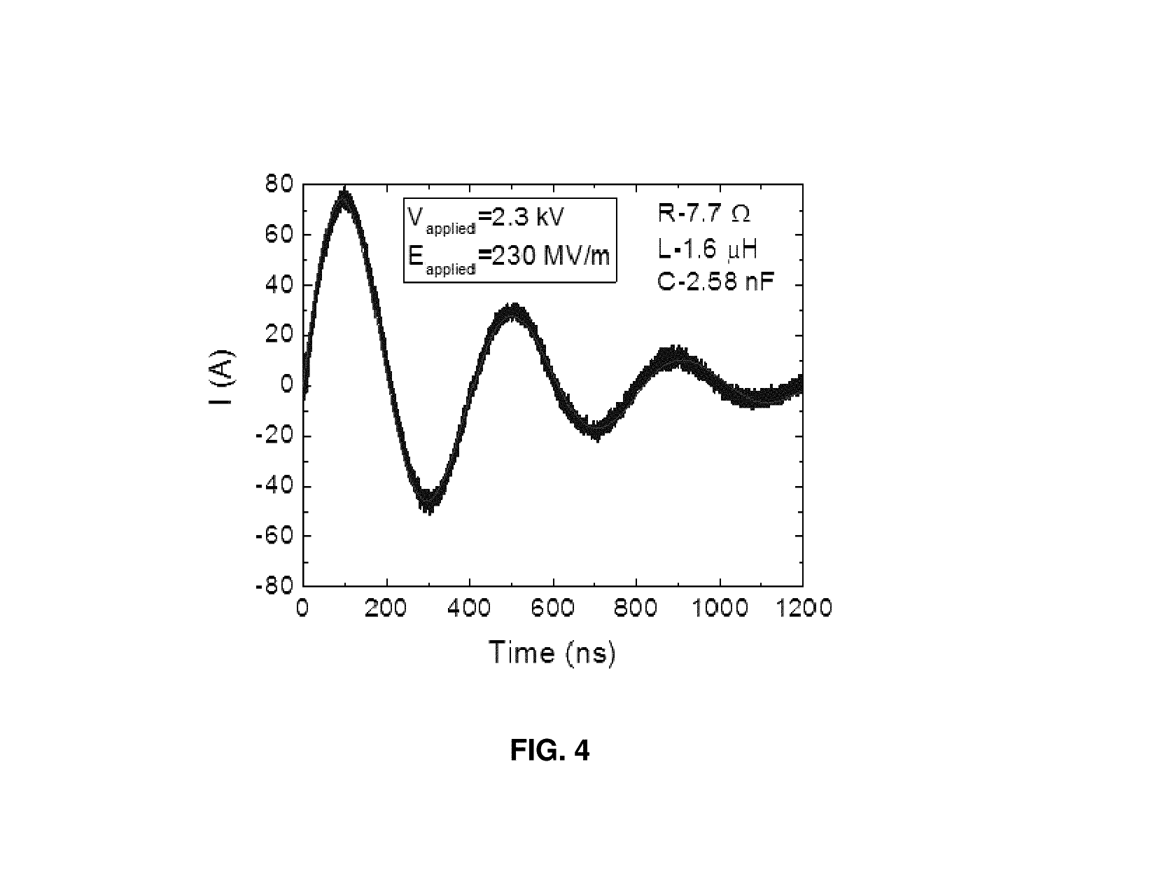

FIG. 4 shows the underdamped RLC response to a 2.3 KV pulsed discharge. The energy density for the dielectric was ˜1.3 J/cc while testing in air. The energy density for the capacitor was ˜60 mJ/cc. This capacitor energy density can be increased by increasing the number of layers, decreasing the edge margin, or using thinner support layers.

The present invention has been described as a method for thermal bonding of multi-layer glass capacitors. It will be understood that the above description is merely illustrative of the applications of the principles of the present invention, the scope of which is to be determined by the claims viewed in light of the specification. Other variants and modifications of the invention will be apparent to those of skill in the art.

We claim:

1. A method for thermal bonding of a multi-layer glass capacitor, comprising:
assembling a plurality of capacitor layers, each layer comprising opposing electrode layers on opposing sides of an alkali-free glass sheet, wherein the edges of the electrode layers are offset from the edges of the glass sheet by an edge margin, and
heating the assembly to above the annealing temperature of the alkali-free glass, thereby causing the glass sheets to bond together at the edge margins.

2. The method of claim 1, wherein the alkali-free glass has a breakdown strength of greater than 1100 MV/m.

3. The method of claim 1, wherein the thickness of the glass sheets is less than 100 μm.

4. The method of claim 3, wherein the thickness of the glass sheets is less than 25 μm.

5. The method of claim 1, wherein the edge margin is selected to provide an adequate protection level from high-voltage flashover of the multi-layer glass capacitor.

6. The method of claim 5, wherein the edge margin is greater than 0.125 inch for a capacitor voltage of 10 kV.

7. The method of claim 1, wherein the annealing temperature is greater than 700° C.

8. The method of claim 1, wherein the electrode layers and glass sheets are circular.

9. The method of claim 1, wherein the electrodes comprise platinum.
